(19) United States
(12) Patent Application Publication
(10) Pub. No.: US 2025/0137153 A1
(43) Pub. Date: May 1, 2025

(54) HYDROGEN GENERATION AND CARBON DIOXIDE STORAGE SYSTEM WITH INCREASED PROCESSING CAPACITY OF CARBON DIOXIDE

(71) Applicants: HYUNDAI MOTOR COMPANY, SEOUL (KR); KIA CORPORATION, SEOUL (KR)

(72) Inventors: Yun Su Lee, Yongin-si (KR); Se Won Pyo, Uiwang-si (KR); Shin Tae Bae, Incheon (KR); Ji Hoon Jang, Suwon-si (KR)

(21) Appl. No.: 18/601,073

(22) Filed: Mar. 11, 2024

(30) Foreign Application Priority Data
Nov. 1, 2023 (KR) 10-2023-0148912

(51) Int. Cl. C25B 15/08; B01D 53/62; B01D 53/78; B01D 53/96; C25B 1/04; C25B 9/19; C25B 13/08

(52) U.S. Cl. CPC C25B 15/087; B01D 53/62; B01D 53/78; B01D 53/965; C25B 1/04; C25B 9/19; C25B 13/08; C25B 15/085; B01D 2251/304; B01D 2251/306; B01D 2251/606; B01D 2257/504; B01D 2258/025

(57) ABSTRACT

A hydrogen generation and carbon dioxide storage system has increased processing capacity of carbon dioxide. The system includes a metal-carbon dioxide battery comprising an anode, a cathode, and an ion exchange membrane positioned between the anode and the cathode, a first supply unit configured to provide a first electrolyte to the anode, a second supply unit configured to provide a second electrolyte comprising hydrogen ions and an aqueous solution of alkali bicarbonate to the cathode, a separation unit, an electrolyte circulation unit located at a rear end of the separation unit, a dissolution unit located at a rear end of the electrolyte circulation unit, and a carbon dioxide purification unit.

### CROSS REFERENCE TO RELATED APPLICATIONS

This application claims, under 35 U.S.C. § 119 (a), the benefit of priority to Korean Patent Application No. 10-2023-0148912 filed on Nov. 1, 2023, the entire contents of which are incorporated herein by reference.

### BACKGROUND

### (a) Technical Field

The present disclosure relates to a hydrogen generation and carbon dioxide storage system with increased processing capacity of carbon dioxide.

### (b) Background Art

In recent years, electrochemical water electrolysis has been actively studied in line with the development of renewable energy sources to combat climate change. In addition, carbon dioxide (CO₂) capture, storage, and conversion technologies are becoming increasingly important for reducing greenhouse gases.

A zinc/aluminum (Zn/Al)-based aqueous battery system is a very economical metal cathode candidate in terms of price and reserves. The zinc/aluminum (Zn/Al)-based aqueous battery system is a system that produces hydrogen and at the same time captures carbon dioxide in the form of a salt such as potassium bicarbonate (KHCO₃).

The above information disclosed in this Background section is provided only for enhancement of understanding of the background of the invention and therefore it may contain information that does not form the prior art that is already known in this country to a person of ordinary skill in the art.

### SUMMARY

The present disclosure has been made in an effort to solve the above-described problems associated with the prior art.

It is an object of the present disclosure to provide a hydrogen generation and carbon dioxide storage system with higher processing capacity of carbon dioxide than a conventional system.

It is another object of the present disclosure to provide a hydrogen generation and carbon dioxide storage system with greater production of alkali bicarbonate than the conventional system.

The objects of the present disclosure are not limited to that described above. The objects of the present disclosure will be clearly understood from the following description of embodiments and could be implemented by means defined in the claims and a combination thereof.

In one aspect, the present disclosure provides a hydrogen generation and carbon dioxide storage system including a metal-carbon dioxide battery including an anode, a cathode, and an ion exchange membrane interposed between the anode and the cathode, a first supply unit configured to provide a first electrolyte to the anode, a second supply unit configured to provide a second electrolyte including hydrogen ions and an aqueous solution of alkali bicarbonate to the cathode, a separation unit configured to separate a product discharged from the cathode into hydrogen gas and a circulating liquid, an electrolyte circulation unit located at a rear end of the separation unit, wherein the electrolyte circulation unit being configured to receive and store the circulating liquid from the separation unit, a dissolution unit located at a rear end of the electrolyte circulation unit, wherein the dissolution unit being configured to dissolve carbon dioxide in a starting material received from the electrolyte circulation unit to manufacture an electrolyte precursor solution, and a carbon dioxide purification unit configured to purify carbon dioxide from a gas mixture comprising carbon dioxide supplied from the outside and to provide the carbon dioxide to the dissolution unit.

The system may further include a filtration unit located between the second supply unit and the dissolution unit, wherein the filtration unit being configured to precipitate and separate alkali bicarbonate from the electrolyte precursor solution received from the dissolution unit to manufacture the second electrolyte and to provide the second electrolyte to the second supply unit.

The anode may include at least one selected from the group consisting of aluminum, zinc, and a combination thereof.

The cathode may include at least one selected from the group consisting of carbon paper, carbon fiber, carbon felt, carbon cloth, metal foam, metal thin film, and a combination thereof or may include a catalyst metal supported on a support.

The ion exchange membrane may include a cation conductive resin.

The first electrolyte may include at least one selected from the group consisting of an aqueous solution of sodium hydroxide, an aqueous solution of potassium hydroxide, and a combination thereof.

The second electrolyte may have a pH of 7 to 9.

The aqueous solution of alkali bicarbonate may include at least one selected from the group consisting of an aqueous solution of sodium bicarbonate (NaHCO₃), an aqueous solution of potassium bicarbonate (KHCO₃), and a combination thereof.

The aqueous solution of alkali bicarbonate included in the second electrolyte may have a concentration of 0.5M to 2M.

The carbon dioxide purification unit may include an absorbent storage module configured to store an absorbent including an aqueous solution of alkali carbonate, an intake module configured to dissolve the carbon dioxide of the gas mixture in the absorbent received from the absorbent storage module to manufacture a concentrate, a degassing module configured to degas the carbon dioxide from the concentrate received from the intake module and to provide the carbon dioxide to the dissolution unit, and an effluent distribution module configured to receive an effluent discharged from the degassing module, to provide some of the effluent to the electrolyte circulation unit, and to provide the remainder of the effluent to the absorbent storage module.

The aqueous solution of alkali carbonate may include at least one selected from the group consisting of an aqueous solution of sodium carbonate (Na₂CO₃), an aqueous solution of potassium carbonate (K₂CO₃), and a combination thereof.

The aqueous solution of alkali carbonate included in the absorbent may have a concentration of 0.01 M to 1 M.

The gas mixture may include at least one selected from the group consisting of steel by-product gas, exhaust gas, and a combination thereof.

The intake module may include an intake separator installed therein, the intake separator being configured to partition the interior space of the intake module into an absorbent flow space and a gas mixture flow space, and carbon dioxide included in a gas mixture flowing in the gas mixture flow space may pass through the intake separator and may be dissolved in an absorbent flowing in the absorbent flow space.

The ratio of flow rate of the absorbent to the gas mixture provided to the intake module may be 1:0.001 to 1:5.

The pressure ratio of the absorbent to the gas mixture provided to the intake module may be 1:0.1 to 1:3.

The amount of carbon dioxide included in residual gas discharged from the intake module may be 0.1% by weight or less.

The degassing module may include a degassing separator installed therein, the degassing separator being configured to partition the interior space of the degassing module into a concentrate flow space and a carbon dioxide degassing space, and carbon dioxide included in a concentrate flowing in the concentrate flow space may pass through the degassing separator and may be discharged to the carbon dioxide degassing space.

The carbon dioxide discharged from the degassing module may have a purity of 99.9 volume % or more.

The effluent distribution module may provide some of the effluent to the electrolyte circulation unit, and some of the effluent may be mixed with the circulating liquid in the electrolyte circulation unit and stored as the starting material.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a hydrogen generation and carbon dioxide storage system according to the present disclosure;

FIG. 2 shows a carbon dioxide purification unit according to the present disclosure;

FIG. 3 shows an intake module according to the present disclosure;

FIG. 4 shows a degassing module according to the present disclosure;

FIG. 5 shows a dissolution unit according to the present disclosure;

FIG. 6 shows the result of measurement of the concentration of carbon dioxide discharged from a carbon dioxide purification unit according to Example 1;

FIG. 7 shows the result of measurement of the concentration of carbon dioxide discharged from a carbon dioxide purification unit according to Example 2; and

FIG. 8 shows the result of measurement of the concentration of carbon dioxide discharged from a carbon dioxide purification unit according to Example 3.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The objects described above, and other objects, features and advantages will be clearly understood from the following preferred embodiments with reference to the attached drawings. However, the present disclosure is not limited to the embodiments and will be embodied in different forms. Rather, the embodiments are provided only to offer thorough and complete understanding of the disclosed contents and sufficiently inform those skilled in the art of the technical concept of the present disclosure.

Like reference numbers refer to like elements throughout the description of the figures. In the drawings, the sizes of structures are exaggerated for clarity. It will be understood that, although the terms “first”, “second”, etc. may be used herein to describe various elements, corresponding elements should not be understood to be limited by these terms, which are used only to distinguish one element from another. For example, within the scope defined by the present disclosure, a first element may be referred to as a second element and similarly, a second element may be referred to as a first element. Singular forms are intended to include plural forms as well, unless the context clearly indicates otherwise.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element or an intervening element may also be present. It will also be understood that, when an element such as a layer, film, region or substrate is referred to as being “under” another element, it can be directly under the other element or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures among other things. For this reason, it should be understood that, in all cases, the term “about” should modify all numbers, figures and/or expressions. In addition, when numeric ranges are disclosed in the description, these ranges are continuous and include all numbers from the minimum to the maximum including the maximum within the range unless otherwise defined. Furthermore, when the range refers to an integer, it includes all integers from the minimum to the maximum including the maximum within the range, unless otherwise defined.

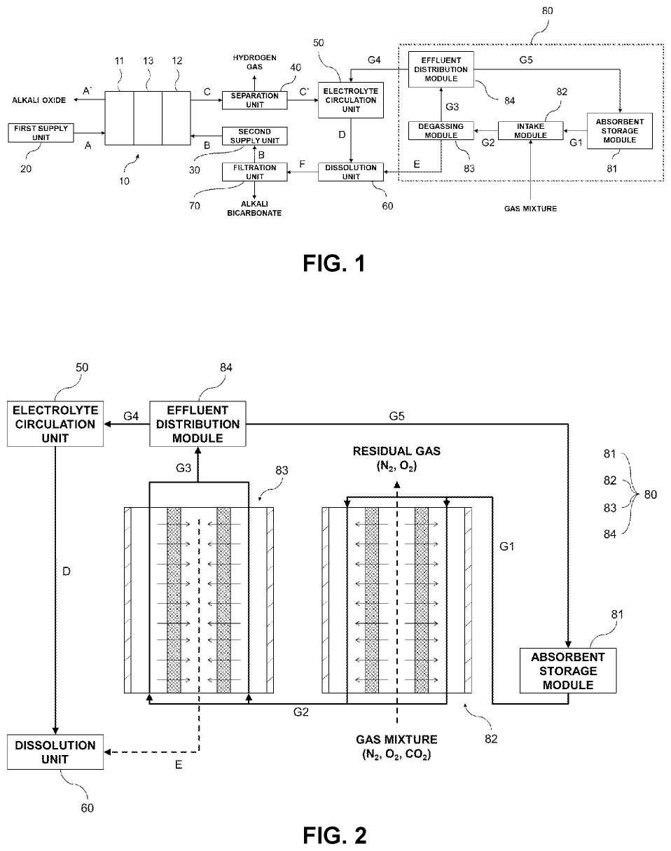

FIG. 1 shows a hydrogen generation and carbon dioxide storage system according to the present disclosure. The system may include a metal-carbon dioxide battery 10 including an anode 11, a cathode 12, and an ion exchange membrane 13 interposed between the anode 11 and the cathode 12, a first supply unit 20 configured to provide a first electrolyte A to the anode 11, and a second supply unit 30 configured to provide a second electrolyte B to the cathode 12.

The anode 11 is an electrode made of a metal material, which may include at least one selected from the group consisting of aluminum, zinc, and a combination thereof.

The first supply unit 20 may include a storage tank configured to receive the first electrolyte A and a pump configured to provide the first electrolyte A to the anode 11.

The first electrolyte A may include at least one selected from the group consisting of an aqueous solution of sodium hydroxide, an aqueous solution of potassium hydroxide, and a combination thereof.

At the anode 11, oxidation reaction, such as Reaction Formula 1-1 or Reaction Formula 1-2 below, may occur. Reaction Formula 1-1 and Reaction Formula 1-2 below are based on the case where the anode 11 is zinc.

Zn+4Na⁺+4OH⁻→4Na⁺+Zn(OH)₄²⁻+2e⁻

Zn(OH)₄²⁻→ZnO+H₂O+2OH⁻ Reaction Formula 1-1:

Zn+4K⁺+4OH⁻→4K⁺+Zn(OH)₄²⁻+2e⁻

Zn(OH)₄²⁻→ZnO+H₂O+2OH⁻ Reaction Formula 1-2:

An alkali oxide, such as zinc oxide, generated at the anode 11 is discharged to the outside, and alkali cations move to the cathode 12 through the ion exchange membrane 13.

The ion exchange membrane 13 may be located between the anode 11 and the cathode 12 to prevent physical contact therebetween. In addition, the ion exchange membrane 13 may prevent mixing between the first electrolyte A and the second electrolyte B, and may conduct the alkali cations generated from the anode 11 to the cathode 12.

The ion exchange membrane 13 may include a cation conductive resin. For example, the ion exchange membrane 13 may include a perfluorosulfonic acid-based resin such as Nafion.

The cathode 12 may induce reaction between the alkali cations moved through the ion exchange membrane 13 and the second electrolyte B to produce hydrogen, and may store carbon dioxide in the form of alkali bicarbonate.

The cathode 12, which is an electrode, may include at least one selected from the group consisting of carbon paper, carbon fiber, carbon felt, carbon cloth, metal foam, metal thin film, and a combination thereof, or may include a catalyst metal supported on a support. Although not particularly limited, the catalyst metal may include a noble metal, such as platinum (Pt), and/or a transition metal, such as nickel (Ni) or molybdenum (Mo).

The second supply unit 30 may include a storage tank configured to receive the second electrolyte B and a pump configured to provide the second electrolyte B to the cathode 12.

The second electrolyte B may include hydrogen ions, an aqueous solution of alkali bicarbonate, and carbon dioxide. The second electrolyte B may further include an aqueous solution of alkali carbonate, which will be described later.

The aqueous solution of alkali bicarbonate may include at least one selected from the group consisting of an aqueous solution of sodium bicarbonate (NaHCO₃), an aqueous solution of potassium bicarbonate (KHCO₃), and a combination thereof.

The aqueous solution of alkali carbonate may include at least one selected from the group consisting of an aqueous solution of sodium carbonate (Na₂CO₃), an aqueous solution of potassium carbonate (K₂CO₃), and a combination thereof.

When the second electrolyte B is provided to the cathode 12, hydrogen gas is generated according to Reaction Formula 2 below, and carbon dioxide is stored in the form of a salt according to Reaction Formula 3-1 and Reaction Formula 3-2 below:

2H++2e⁻→H₂ Reaction Formula 2:

2Na⁺+Na₂CO₃+3CO₂+3H₂O→4Na⁺+4HCO₃⁻+2H⁺→4NaHCO₃+2H⁺Na⁺+HCO₃⁻→NaHCO₃ Reaction Formula 3-1:

2K⁺+K₂CO₃+3CO₂+3H₂O→4K⁺+4HCO₃⁻+2H⁺→4KHCO₃+2H⁺K⁺+HCO₃⁻→KHCO₃ Reaction Formula 3⁻2:

Consequently, a product C discharged from the cathode 12 may include an unreacted material of the second electrolyte B, hydrogen gas, and an aqueous solution of alkali bicarbonate.

The system may include a separation unit 40 configured to separate the product C discharged from the cathode 12 into hydrogen gas and a circulating liquid C′, an electrolyte circulation unit 50 located at a rear end of the separation unit 40, the electrolyte circulation unit being configured to receive and store the circulating liquid C′ from the separation unit 40, a dissolution unit 60 located at a rear end of the electrolyte circulation unit 50, the dissolution unit being configured to dissolve carbon dioxide in a starting material D received from the electrolyte circulation unit 50 to manufacture an electrolyte precursor solution F, and a filtration unit 70 located between the second supply unit 30 and the dissolution unit 60, the filtration unit being configured to precipitate and separate alkali bicarbonate from the electrolyte precursor solution F received from the dissolution unit 60 to manufacture a second electrolyte B and to provide the second electrolyte B to the second supply unit 30.

In addition, the system may include a carbon dioxide purification unit 80 configured to purify carbon dioxide E from a gas mixture including carbon dioxide supplied from the outside and to provide the carbon dioxide E to the dissolution unit 60.

In the present disclosure, carbon dioxide may be sequentially processed through the carbon dioxide purification unit 80 located at a front end and the dissolution unit 60 located at a rear end based on the flow of the gas mixture, whereby it is possible to increase processing capacity of the carbon dioxide. In addition, since high-purity carbon dioxide E that has passed through the carbon dioxide purification unit 80 is provided to the dissolution unit 60, it is possible to reduce the process pressure, the flow rate, etc., and therefore it is possible to considerably reduce the scale of the dissolution unit 60.

FIG. 2 shows the carbon dioxide purification unit 80 according to the present disclosure. The carbon dioxide purification unit 80 may include an absorbent storage module 81 configured to store an absorbent G1 including an aqueous solution of alkali carbonate, an intake module 82 configured to dissolve the carbon dioxide of the gas mixture in the absorbent G1 received from the absorbent storage module 81 to manufacture a concentrate G2, a degassing module 83 configured to degas the carbon dioxide E from the concentrate G2 received from the intake module 82 and to provide the carbon dioxide E to the dissolution unit 60, and an effluent distribution module 84 configured to receive an effluent G3 discharged from the degassing module 83, to provide some G4 of the effluent to the electrolyte circulation unit 50, and to provide the remainder G5 of the effluent to the absorbent storage module 81.

The aqueous solution of alkali carbonate may include at least one selected from the group consisting of an aqueous solution of sodium carbonate (Na₂CO₃), an aqueous solution of potassium carbonate (K₂CO₃), and a combination thereof.

The concentration of the aqueous solution of alkali carbonate included in the absorbent G1 may be 0.01 M to 1 M, or 0.1 M to 0.5 M. A low-concentration aqueous solution of alkali carbonate should be used as the absorbent G1 to increase the solubility and selectivity of the carbon dioxide included in the gas mixture.

The carbon dioxide purification unit 80 may further include an absorbent provision unit (not shown) configured to provide the absorbent G1 to the absorbent storage module 81.

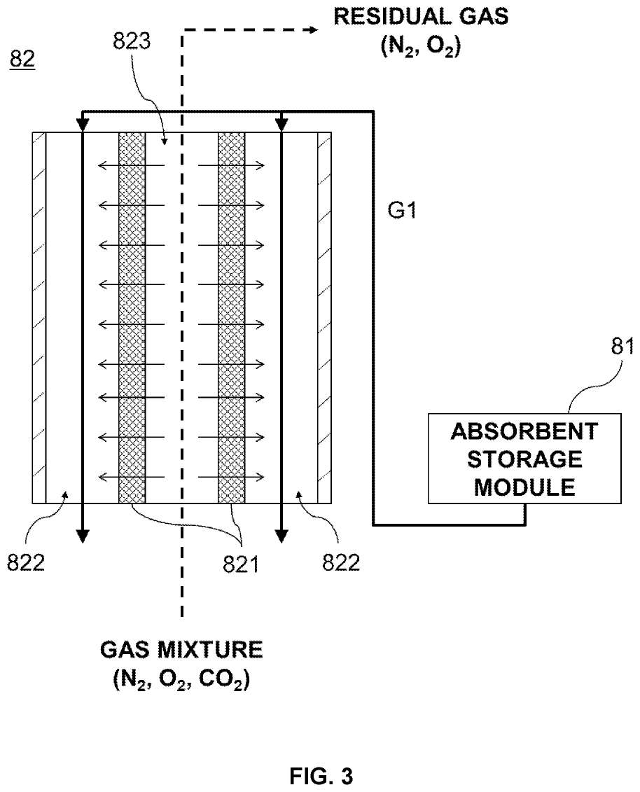

FIG. 3 shows the intake module 82 according to the present disclosure. The intake module 82 may include an intake separator 821 installed therein. The intake separator 821 may partition the interior space of the intake module 82 into an absorbent flow space 822 and a gas mixture flow space 823.

The absorbent G1 may be provided to the absorbent flow space 822, and an external gas mixture including carbon dioxide may be provided to the gas mixture flow space 823. The absorbent G1 and the gas mixture may flow in a counter flow form with opposite flow directions. For example, based on FIG. 3, when the absorbent G1 is provided to the upper part of the intake module 82 and discharged to the lower part thereof, the gas mixture may be provided to the lower part of the intake module 82 and discharged to the upper part thereof. This may serve to increase the contact time between the absorbent G1 and the gas mixture.

The intake separator 821 may include hollow fibers made of a polyolefin-based material such as polypropylene. The surface of the intake separator 821 may include micropores such that the gas mixture can pass through the intake separator 821, but the absorbent G1 cannot be diffused.

The gas mixture may refer to a mixture of carbon dioxide, nitrogen, oxygen, hydrogen, and the like. Specifically, the gas mixture may include at least one selected from the group consisting of steel by-product gas, exhaust gas, and a combination thereof.

Carbon dioxide in the gas mixture has a high solubility in the absorbent G1 at high pressure, but the remaining gases, such as nitrogen and oxygen, have low solubility in the absorbent G1. At the interface between the gas mixture and the intake separator 821, therefore, the carbon dioxide passes through the intake separator 821 and is dissolved and separated in the absorbent G1, and the remaining gases are discharged as residual gas.

The carbon dioxide may be dissolved in the absorbent G1 according to Reaction Formula 4 below, which is based on the case where the absorbent G1 is an aqueous solution of potassium carbonate.

H₂O+CO₂→H⁺+HCO₃⁻

K⁺+CO₃⁻+H⁺→KHCO₃

K⁺+HCO₃⁻→KHCO₃

Net: K₂CO₃+H₂O+CO₂→KHCO₃ Reaction Formula 4:

In the intake module 82, most carbon dioxide in the gas mixture may be dissolved in the absorbent G1. Specifically, the content of carbon dioxide included in the residual gas discharged from the intake module 82 may be 0.1% by weight or less.

The intake module 82 may dissolve carbon dioxide in the absorbent G1 to manufacture a concentrate G2 and may provide the concentrate G2 to the degassing module 83 located at a rear end thereof.

The carbon dioxide absorption rate of the absorbent G1 may be adjusted in various ways. For example, the ratio of flow rate of the absorbent G1 to the gas mixture provided to the intake module 82 may be adjusted to 1:0.001 to 1:5, or the pressure ratio of the absorbent G1 to the gas mixture provided to the intake module 82 may be adjusted to 1:0.1 to 1:3.

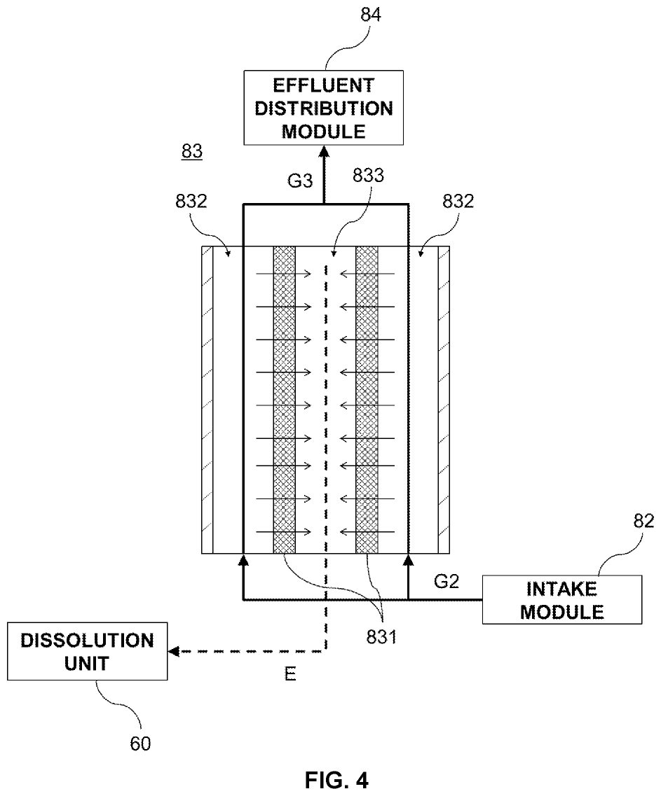

FIG. 4 shows the degassing module 83 according to the present disclosure. The degassing module 83 may include a degassing separator 831 installed therein. The degassing separator 831 may partition the interior space of the degassing module 83 into a concentrate flow space 832 and a carbon dioxide degassing space 833.

The degassing separator 831 may include hollow fibers made of a polyolefin-based material such as polypropylene. The surface of the degassing separator 831 may include micropores such that the concentrate G2 cannot pass but carbon dioxide E discharged from the concentrate G2 can pass.

The degassing module 83 may degas carbon dioxide dissolved in the concentrate G2 and may supply the carbon dioxide to the carbon dioxide degassing space 833. More specifically, the concentrate G2 may be supplied to the concentrate flow space 832, and gas in the carbon dioxide degassing space 833 may be discharged to the outside, whereby the pressure in the degassing module 83 may be adjusted such that the carbon dioxide dissolved in the concentrate G2 can be degassed, and therefore the concentrate G2 may be separated into an effluent G3 from which carbon dioxide has been degassed and carbon dioxide E.

The pressure in the degassing module 83 may be normal pressure or vacuum, but is not limited thereto as long as the carbon dioxide in the concentrate G2 can be degassed.

The purity of the carbon dioxide E discharged from the degassing module 83 may be 99.9 volume % or more. The high-purity carbon dioxide E may be provided to the dissolution unit 60.

The effluent G3 may include an aqueous solution of alkali carbonate, which is the absorbent G1, and an aqueous solution of alkali bicarbonate formed through reaction between the absorbent G1 and carbon dioxide.

The effluent distribution module 84 may provide some G4 of the effluent to the electrolyte circulation unit 50, and some G4 of the effluent may be mixed with the circulating liquid C′ in the electrolyte circulation unit 50 and stored as a starting material D. The amount of some G4 of the effluent is not particularly limited, and may be adjusted to a level to which water consumed according to Reaction Formula 2 and Reaction Formula 3 is replenished in the metal-carbon dioxide battery 10.

The effluent distribution module 84 may provide the remainder G5 of the effluent to the absorbent storage module 81.

The system is characterized by including a kind of electrolyte circulation system constituted by the separation unit 40, the electrolyte circulation unit 50, the dissolution unit 60, the filtration part 70, and the second supply unit 30. As a result, it is possible to supply an aqueous solution of alkali bicarbonate to the cathode 12 at a constant concentration, to increase the throughput of carbon dioxide, and to produce alkali bicarbonate.

The separation unit 40 may include a gas-liquid separation device configured to separate hydrogen gas from a liquid product C discharged from the cathode 12.

The separation unit 40 may provide a circulating liquid C′ obtained by separating hydrogen gas from the product C to the electrolyte circulation unit 50. The circulating liquid C′ may include an unreacted material of the second electrolyte B and an aqueous solution of alkali bicarbonate.

The electrolyte circulation unit 50 may include a storage tank configured to receive a starting material D including the circulating liquid C′ and some G4 of the effluent received from the effluent distribution module 84 and a pump configured to provide the starting material D to the dissolution unit 60.

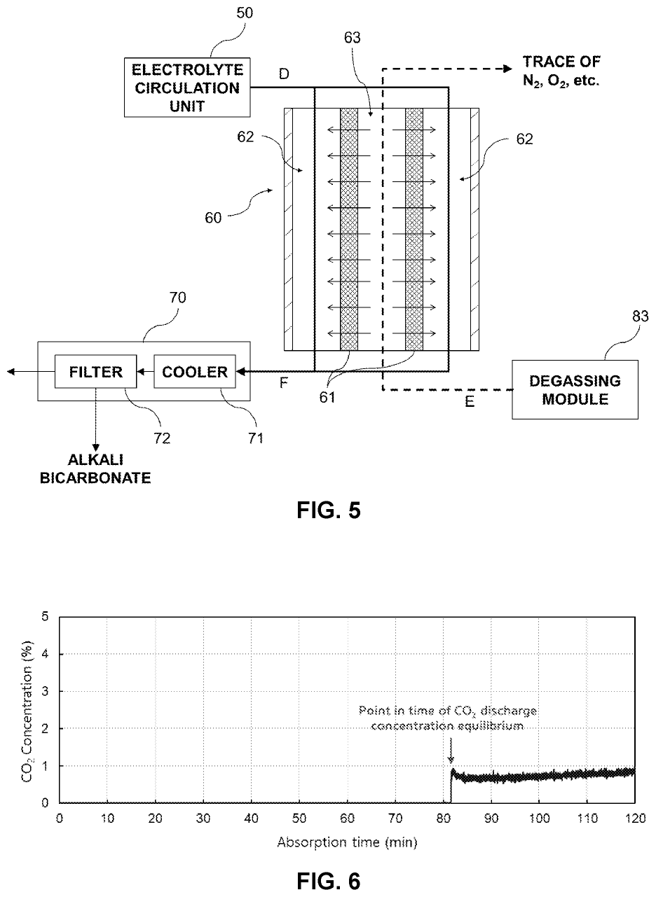

FIG. 5 shows the dissolution unit 60 according to the present disclosure. The dissolution unit 60 may include a dissolution separator 61 installed therein. The dissolution separator 61 may partition the interior space of the dissolution unit 60 into an electrolyte flow space 62 and a carbon dioxide flow space 63.

A starting material D may be provided to the electrolyte flow space 62, and high-purity carbon dioxide E may be provided to the carbon dioxide flow space 63. The starting material D and carbon dioxide E may flow in a counter flow form with opposite flow directions. For example, based on FIG. 5, when carbon dioxide E is provided to the lower part of the dissolution unit 60 and discharged to the upper part thereof, the starting material D may be provided to the upper part of the dissolution unit 60 and discharged to the lower part thereof. This may serve to increase the contact time between the carbon dioxide E and the starting material D.

The dissolution separator 61 may include hollow fibers made of a polyolefin-based material such as polypropylene. The surface of the dissolution separator 61 may include micropores such that the starting material D cannot pass but the carbon dioxide E can pass.

The dissolution reaction of the carbon dioxide occurs as represented by Reaction Formula 5 and Reaction Formula 6 below.

CO₂+H₂O→H⁺+HCO₃⁻ Reaction Formula 5:

CO₂+K₂CO₃+H₂O→2KHCO₃ Reaction Formula 6:

The pressure of the carbon dioxide flow space 63 may be adjusted to 1 bar to 10 bar in order to cause the dissolution reaction of the carbon dioxide E. The dissolution unit 60 may further include a sensor configured to measure the pressure of the carbon dioxide flow space 63 and a pressure control device configured to control the pressure.

In addition, the ratio of the flow rate of carbon dioxide E to the flow rate of the starting material D flowing in the dissolution unit 60 may be 1:0.001 to 1:5. When the ratio of the flow rate is within the above range, the starting material D and carbon dioxide may efficiently come into contact with each other.

The dissolution unit 60 may supply an electrolyte precursor solution F obtained through the dissolution reaction of carbon dioxide E to the filtration unit 70. The filtration portion 70 may include a cooler 71 configured to lower the temperature of the electrolyte precursor solution F such that alkali bicarbonate is precipitated from the electrolyte precursor solution F and a filter 72 configured to separate the precipitated alkali bicarbonate. When the cooler 71 lowers the temperature of the electrolyte precursor solution F, the solubility of the alkali bicarbonate is lowered, whereby the alkali bicarbonate is precipitated. The precipitated alkali bicarbonate may be easily separated and collected through the filter 72.

The cooler 71 may cool the electrolyte precursor solution F to about 0° C. to 25° C., or 5° C. to 10° C.

Alkali bicarbonate may be precipitated and separated from the electrolyte precursor solution F to obtain the second electrolyte B.

The pH of the second electrolyte B may be pH 7 to pH 9, the temperature thereof may be 0° C. to 25° C., and the concentration of the aqueous solution of alkali bicarbonate included therein may be 0.5M to 2M.

Other forms of the present disclosure will be more specifically described through the following examples. The following examples are illustrative only to aid in the understanding of the present disclosure and are not intended to limit the scope of the present disclosure.

### Example 1

A carbon dioxide purification unit was configured, as shown in FIG. 2. A material including polypropylene hollow fibers was used as each of an intake separator and a degassing separator. 0.1 M of an aqueous solution of potassium carbonate (K₂CO₃) was used as an absorbent. A gas mixture supplied to an intake module was constituted by carbon dioxide and nitrogen provided at a flow rate of 1:3. Specifically, carbon dioxide was provided to the intake module at a flow rate of 3.75 l/min and nitrogen at a flow rate of 11.25 l/min. The pressure in the intake module was adjusted to about 6 bar.

About 50 liters of the absorbent was provided to the intake module at a flow rate of about 5 l/min, and carbon dioxide was dissolved in the absorbent to obtain a concentrate and residual gas discharged from the intake module. The concentrate was provided to a degassing module to degas carbon dioxide, and carbon dioxide and an effluent discharged from the degassing module were collected.

The content of carbon dioxide and nitrogen in the residual gas discharged from the intake module was measured, and the composition of carbon dioxide discharged from the degassing module was measured. The results are shown in Table 1 below.

### COMPARATIVE EXAMPLE

A carbon dioxide purification unit was operated in the same manner as in Example 1 except that an absorbent was replaced with 2 M of an aqueous solution of potassium carbonate. The content of carbon dioxide and nitrogen in residual gas according to Comparative Example was measured, and the composition of carbon dioxide discharged from a degassing module was measured. The results are shown in Table 1 below.

TABLE 1

| | CO₂ | | | | |
|---|---|---|---|---|---|
| | absorption | Composition of residual gas | | Composition of carbon | |
| | rate | [mass %] | | dioxide [mass %] | |
| Classification | [%] | N₂ | CO₂ | N₂ | CO₂ |
| Example 1 | 99.99 | 99.99 | 0.01 | — | 100 |
| Comparative | 83.94 | 93.00 | 7.00 | 1.20 | 98.80 |
| Example | | | | | |

Referring to Table 1, it can be seen that Example 1 using a low-concentration absorbent has a higher absorption rate of carbon dioxide in a gas mixture than Comparative Example, and can produce high-purity carbon dioxide in the degassing module.

FIG. 6 shows the result of measurement of the concentration of carbon dioxide discharged from the carbon dioxide purification unit according to Example 1.

It can be seen that an initial carbon dioxide dissolution rate is 99.99% and lasts for about 80 minutes.

### Example 2

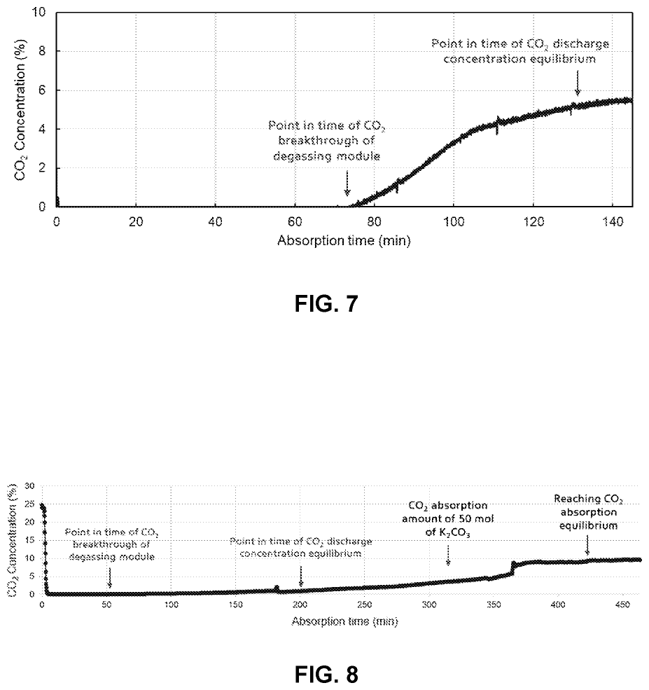

A carbon dioxide purification unit was operated in the same manner as in Example 1 except that an absorbent was replaced with 0.3 M of an aqueous solution of potassium carbonate. FIG. 7 shows the result of measurement of the concentration of carbon dioxide discharged from the carbon dioxide purification unit according to Example 2. The point in time of carbon dioxide discharge concentration equilibrium is the point in time at which all potassium carbonate (K₂CO₃) is converted to potassium bicarbonate (KHCO₃), and carbon dioxide is dissolved in water. At this time, pH of the absorbent is 8.25 and pH of an effluent is 8.15, and there is little difference therebetween. This means that carbon dioxide has been absorbed by water. It can be seen that carbon dioxide is less soluble in an aqueous solution of potassium bicarbonate than in water.

### Example 3

A carbon dioxide purification unit was operated in the same manner as in Example 1 except that an absorbent was replaced with 1 M of an aqueous solution of potassium carbonate. FIG. 8 shows the result of measurement of the concentration of carbon dioxide discharged from the carbon dioxide purification unit according to Example 3. The initial carbon dioxide absorption rate is 99.97%, and carbon dioxide begins to be discharged from a degassing module after approximately 60 minutes, at which point in time carbon dioxide absorbed by water is discharged. The amount of water is reduced due to reaction of carbon dioxide as the concentration of the absorbent increases, and the carbon dioxide dissolution rate is reduced as the separator system run time increases. Consequently, it can be seen that a lower-concentration absorbent should be used as much as possible.

The examples and experimental examples of the present disclosure have been described in detail above, but the scope of the present disclosure is not limited to the examples and experimental examples described above, and various modifications and improvements of those skilled in the art using the basic concepts of the present disclosure as defined in the appended claims are also included in the scope of the present disclosure.

As is apparent from the foregoing, according to the present disclosure, it is possible to obtain a hydrogen generation and carbon dioxide storage system with higher processing capacity of carbon dioxide than a conventional system.

According to the present disclosure, it is possible to obtain a hydrogen generation and carbon dioxide storage system with very low discharge of carbon dioxide (400 ppm or less).

According to the present disclosure, it is possible to obtain a hydrogen generation and carbon dioxide storage system with greater production of alkali bicarbonate than the conventional system.

The effects of the present disclosure are not limited to the effects mentioned above. It is to be understood that the effects of the present disclosure include all effects that can be deduced from the above description.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A hydrogen generation and carbon dioxide storage system comprising:
a metal-carbon dioxide battery comprising an anode, a cathode, and an ion exchange membrane positioned between the anode and the cathode;
a first supply unit configured to provide a first electrolyte to the anode;
a second supply unit configured to provide a second electrolyte comprising hydrogen ions and an aqueous solution of alkali bicarbonate to the cathode;
a separation unit configured to separate a product discharged from the cathode into hydrogen gas and a circulating liquid;
an electrolyte circulation unit located at a rear end of the separation unit, wherein the electrolyte circulation unit is configured to receive and store the circulating liquid from the separation unit;
a dissolution unit located at a rear end of the electrolyte circulation unit, wherein the dissolution unit is configured to dissolve carbon dioxide in a starting material received from the electrolyte circulation unit to manufacture an electrolyte precursor solution; and
a carbon dioxide purification unit configured to purify carbon dioxide from a gas mixture comprising carbon dioxide supplied from an outside and to provide the carbon dioxide to the dissolution unit.

2. The hydrogen generation and carbon dioxide storage system according to claim 1, further comprising a filtration unit located between the second supply unit and the dissolution unit, wherein the filtration unit is configured to precipitate and separate alkali bicarbonate from the electrolyte precursor solution received from the dissolution unit to manufacture the second electrolyte and to provide the second electrolyte to the second supply unit.

3. The hydrogen generation and carbon dioxide storage system according to claim 1, wherein the anode comprises at least one selected from a group consisting of aluminum, zinc, and a combination thereof.

4. The hydrogen generation and carbon dioxide storage system according to claim 1, wherein the cathode comprises at least one selected from a group consisting of carbon paper, carbon fiber, carbon felt, carbon cloth, metal foam, metal thin film, and a combination thereof; or comprises a catalyst metal supported on a support.

5. The hydrogen generation and carbon dioxide storage system according to claim 1, wherein the ion exchange membrane comprises a cation conductive resin.

6. The hydrogen generation and carbon dioxide storage system according to claim 1, wherein the first electrolyte comprises at least one selected from a group consisting of an aqueous solution of sodium hydroxide, an aqueous solution of potassium hydroxide, and a combination thereof.

7. The hydrogen generation and carbon dioxide storage system according to claim 1, wherein the second electrolyte has a pH of 7 to 9.

8. The hydrogen generation and carbon dioxide storage system according to claim 1, wherein the aqueous solution of alkali bicarbonate comprises at least one selected from a group consisting of an aqueous solution of sodium bicarbonate (NaHCO₃), an aqueous solution of potassium bicarbonate (KHCO₃), and a combination thereof.

9. The hydrogen generation and carbon dioxide storage system according to claim 1, wherein a concentration of the aqueous solution of alkali bicarbonate in the second electrolyte ranges from 0.5M to 2M.

10. The hydrogen generation and carbon dioxide storage system according to claim 1, wherein the carbon dioxide purification unit comprises:
an absorbent storage module configured to store an absorbent comprising an aqueous solution of alkali carbonate;
an intake module configured to dissolve the carbon dioxide of the gas mixture in the absorbent received from the absorbent storage module to manufacture a concentrate;
a degassing module configured to degas the carbon dioxide from the concentrate received from the intake module, and to provide the carbon dioxide to the dissolution unit; and
an effluent distribution module configured to receive an effluent discharged from the degassing module, to provide some of the effluent to the electrolyte circulation unit, and to provide the remainder of the effluent to the absorbent storage module.

11. The hydrogen generation and carbon dioxide storage system according to claim 10, wherein the aqueous solution of alkali carbonate comprises at least one selected from a group consisting of an aqueous solution of sodium carbonate (Na₂CO₃), an aqueous solution of potassium carbonate (K₂CO₃), and a combination thereof.

12. The hydrogen generation and carbon dioxide storage system according to claim 10, wherein a concentration of the aqueous solution of alkali carbonate in the absorbent ranges from 0.01 M to 1 M.

13. The hydrogen generation and carbon dioxide storage system according to claim 10, wherein the gas mixture comprises at least one selected from a group consisting of steel by-product gas, exhaust gas, and a combination thereof.

14. The hydrogen generation and carbon dioxide storage system according to claim 10, wherein:
the intake module comprises an intake separator, the intake separator being configured to partition an interior space of the intake module into an absorbent flow space and a gas mixture flow space; and
carbon dioxide included in a gas mixture flowing in the gas mixture flow space passes through the intake separator and is dissolved in an absorbent flowing in the absorbent flow space.

15. The hydrogen generation and carbon dioxide storage system according to claim 10, wherein a ratio of flow rate of the absorbent to the gas mixture provided to the intake module is 1:0.001 to 1:5.

16. The hydrogen generation and carbon dioxide storage system according to claim 10, wherein a pressure ratio of the absorbent to the gas mixture provided to the intake module is 1:0.1 to 1:3.

17. The hydrogen generation and carbon dioxide storage system according to claim 10, wherein an amount of carbon dioxide in residual gas discharged from the intake module is 0.1% by weight or less.

18. The hydrogen generation and carbon dioxide storage system according to claim 10, wherein:
the degassing module comprises a degassing separator, the degassing separator being configured to partition an interior space of the degassing module into a concentrate flow space and a carbon dioxide degassing space; and
carbon dioxide included in a concentrate flowing in the concentrate flow space passes through the degassing separator and is discharged to the carbon dioxide degassing space.

19. The hydrogen generation and carbon dioxide storage system according to claim 10, wherein the carbon dioxide discharged from the degassing module has a purity of 99.9 volume % or more.

20. The hydrogen generation and carbon dioxide storage system according to claim 10, wherein
the effluent distribution module provides a portion of the effluent to the electrolyte circulation unit, and the portion of the effluent is mixed with the circulating liquid in the electrolyte circulation unit and stored as the starting material.
